(19) United States
(12) Patent Application Publication
(10) Pub. No.: US 2025/0023172 A1
(43) Pub. Date: Jan. 16, 2025

(54) BATTERY PACK

(71) Applicant: MURATA MANUFACTURING CO., LTD., Kyoto (JP)

(72) Inventor: Hideyasu TAKATSUJI, Kyoto (JP)

(21) Appl. No.: 18/897,960

(22) Filed: Sep. 26, 2024

Related U.S. Application Data
(63) Continuation of application No. PCT/JP2023/001904, filed on Jan. 23, 2023.

(30) Foreign Application Priority Data
Mar. 31, 2022 (JP) 2022-058625

(51) Int. Cl. H01M 50/24; H01M 10/613; H01M 10/6551; H01M 50/213; H01M 50/289; H01M 50/503; H01M 50/507

(52) U.S. Cl. CPC H01M 50/24; H01M 10/613; H01M 10/6551; H01M 50/213; H01M 50/289; H01M 50/503; H01M 50/507

(57) ABSTRACT

A battery pack is provided and includes a secondary battery; an exterior case that houses the secondary battery; a lead plate electrically connected to a terminal of the secondary battery; a first member that surrounds a connecting portion where the terminal and the lead plate are connected, is sandwiched between the secondary battery and the lead plate around the connecting portion, and has waterproofness; and a second member that is in contact with the lead plate and the exterior case and has heat dissipation.

### CROSS SECTION TO RELATED APPLICATIONS

The present application is a continuation of PCT patent application no. PCT/JP2023/001904, filed on Jan. 23, 2023, which claims priority to Japanese patent application no. 2022-058625, filed on Mar. 31, 2022, the entire contents of which are incorporated herein by reference.

### BACKGROUND

The present disclosure relates to a battery pack.

A battery unit is provided and includes a plurality of battery blocks including a plurality of batteries, a battery holder that holds the plurality of batteries, and a metal plate that is attached to the battery holder and electrically connected to terminals of the batteries; a housing that houses the plurality of battery blocks; and a cushioning material that is arranged between the battery block and the housing and has heat dissipation.

A battery pack is provided and includes a plurality of battery cells; a battery holder that holds the plurality of battery cells; and a housing that houses the plurality of battery cells and the battery holder. The battery pack includes: a first lead plate electrically connected to a first end of the battery cell; a first inner waterproof sheet between the battery cell and the first lead plate; and a first outer waterproof sheet between the first lead plate and the battery holder.

### SUMMARY

The present disclosure relates to a battery pack.

The battery unit described in the Background section does not have a waterproof function, and there is a risk that water may enter the terminal of the battery. In addition, although the battery pack described in the Background section has a waterproof function, the heat of the battery cell is prevented from being transmitted from the battery holder to the housing by the first outer waterproof sheet, and there is a possibility that the heat of the battery cell is not sufficiently released to the outside of the battery pack.

The present disclosure, in an embodiment, relates to improve waterproofness and heat dissipation in a battery pack.

A battery pack of the present disclosure, in an embodiment, includes: a secondary battery; an exterior case that houses the secondary battery; a lead plate electrically connected to a terminal of the secondary battery; a first member that surrounds a connecting portion where the terminal and the lead plate are connected, is sandwiched between the secondary battery and the lead plate around the connecting portion, and has waterproofness; and a second member that is in contact with the lead plate and the exterior case and has heat dissipation.

According to the present disclosure in an embodiment, in the battery pack, waterproofness and heat dissipation can be improved.

### BRIEF DESCRIPTION OF THE FIGURES

FIG. 1 is a perspective view of a battery pack according to an embodiment.

FIG. 2 is an exploded perspective view of the battery pack according to an embodiment.

FIG. 3 is an enlarged longitudinal sectional view of a positive electrode terminal side of a secondary battery in the battery pack according to an embodiment.

FIG. 4 is an enlarged longitudinal sectional view of a negative electrode terminal side of the secondary battery in the battery pack according to an embodiment.

FIG. 5 is an exploded perspective view of a battery pack according to an embodiment.

FIG. 6 is an enlarged longitudinal sectional view of a positive electrode terminal side of a battery unit in a state where a set of sheets is arranged.

FIG. 7 is an enlarged longitudinal sectional view of the positive electrode terminal side of a secondary battery in the battery pack according to an embodiment.

FIG. 8 is an enlarged longitudinal sectional view of a negative electrode terminal side of the secondary battery in the battery pack according to an embodiment.

FIG. 9 is an enlarged longitudinal sectional view of a positive electrode terminal side of a secondary battery in a battery pack according to an embodiment.

FIG. 10 is an enlarged longitudinal sectional view of a positive electrode terminal side of a secondary battery in a battery pack according to an embodiment.

### DETAILED DESCRIPTION

The present disclosure will be described in further detail including with reference to the drawings according to an embodiment. Note that the present disclosure is not limited thereto. Each embodiment is illustrative, and replacement and combination of a part of configurations illustrated in the different embodiments can be performed. In a second embodiment and subsequent embodiments, matters common to those of a first embodiment may not be described, and only differences may be described. In particular, a similar effect by a similar structure may not be sequentially referred to for each embodiment.

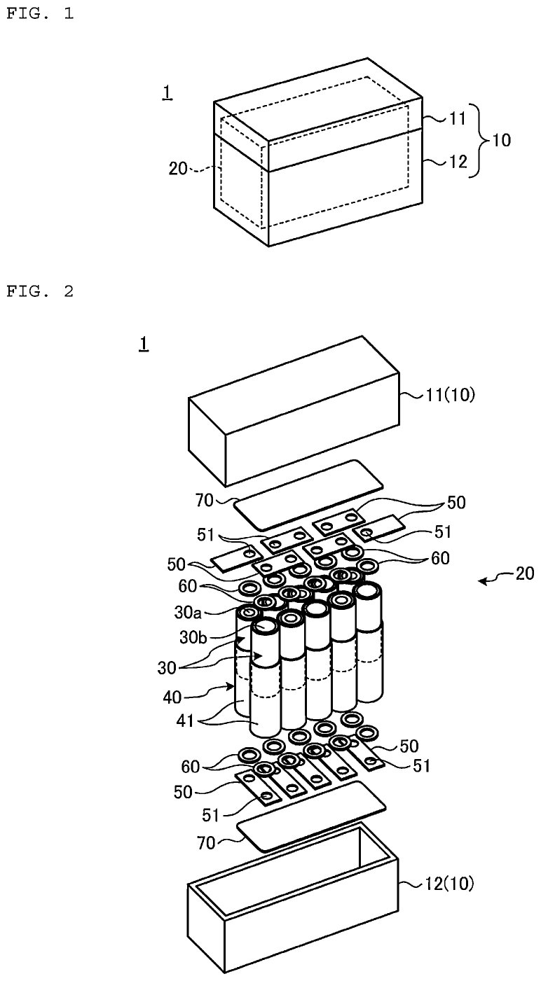

FIG. 1 is a perspective view of a battery pack according to a first embodiment. FIG. 2 is an exploded perspective view of the battery pack according to the first embodiment.

The battery pack 1 can be applied as a power source to an electronic device, an electric vehicle, an electric tool, and the like. As illustrated in FIG. 1, the battery pack 1 includes an exterior case 10 and a battery unit 20.

The exterior case 10 has a box shape and houses the battery unit 20. The exterior case 10 includes a first case portion 11 and a second case portion 12. As illustrated in FIG. 2, the battery unit 20 includes a plurality of secondary batteries 30, a holder 40, lead plates 50, a first member 60, and a second member 70.

The secondary battery 30 is, for example, a lithium ion battery. The secondary battery 30 has a columnar shape. The plurality of secondary batteries 30 are arranged such that orientations of positive electrode terminals 30a and orientations of negative electrode terminals 30b are different from those of the secondary batteries 30 adjacent to each other. Note that it goes without saying that the arrangement of the plurality of secondary batteries 30 is not limited to this.

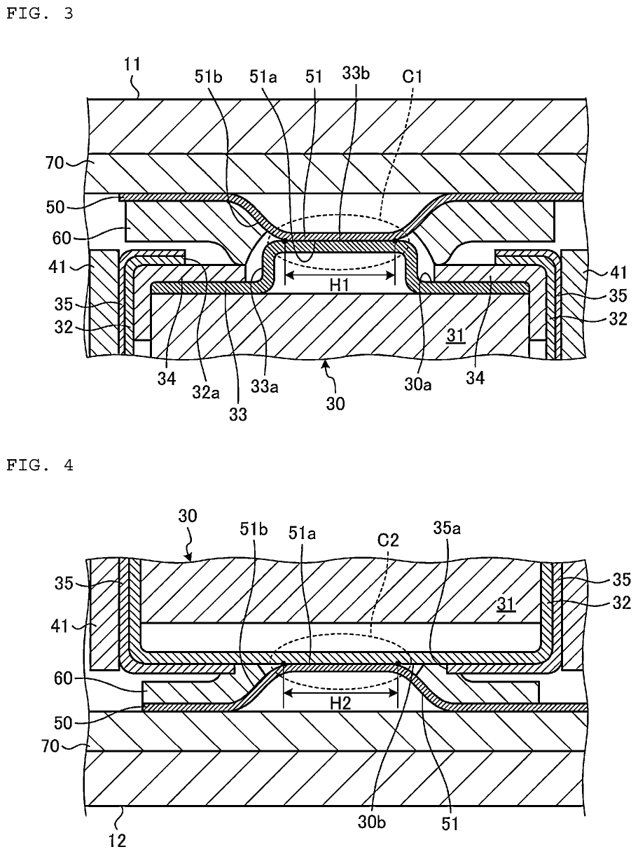

FIG. 3 is an enlarged longitudinal sectional view of the positive electrode terminal side of the secondary battery in the battery pack according to the first embodiment. FIG. 4 is an enlarged longitudinal sectional view of the negative electrode terminal side of the secondary battery in the battery pack according to the first embodiment. The secondary battery 30 includes an electrode assembly 31, a can 32, a lid 33, a first insulating member 34, and a second insulating member 35.

The electrode assembly 31 is formed by laminating and winding a plurality of sheet-like positive electrodes (not illustrated) and a plurality of sheet-like negative electrodes (not illustrated) with a separator (not illustrated) interposed therebetween.

As illustrated in FIG. 3, the can 32 has a tubular shape having an opening 32a on one end side. The can 32 has conductivity and is electrically connected to the negative electrode of the electrode assembly 31. The lid 33 has a plate shape that covers the opening 32a of the can 32 from the inside of the can 32, and has a protrusion 33a at the central portion. The lid 33 has conductivity and is electrically connected to the positive electrode of the electrode assembly 31. The can 32 and the lid 33 are made of, for example, iron, SUS, or aluminum.

The first insulating member 34 electrically insulates the can 32 from the lid 33. The first insulating member 34 is made of, for example, elastic rubber having electrical insulation properties. The first insulating member 34 has, for example, an annular shape having an L-shaped section, and is sandwiched between the peripheral edge portion of the lid 33 and the peripheral edge portion of the opening 32a of the can 32.

A portion outside the lid 33 surrounded by the first insulating member 34, that is, a portion where the lid 33 is exposed constitutes the positive electrode terminal 30a of the secondary battery 30.

The second insulating member 35 is a member for providing an insulating portion on the outer peripheral surface of the can 32. The second insulating member 35 is, for example, a polyimide film, and covers the outer peripheral surface of the can 32. As illustrated in FIG. 4, the second insulating member 35 has an opening 35a on the end surface side of the can 32 on the side opposite to the lid 33.

A portion of the outer surface of the can 32 surrounded by the opening 35a of the second insulating member 35, that is, a portion of the outer surface of the can 32 exposed on the side opposite to the lid 33 constitutes the negative electrode terminal 30b of the secondary battery 30.

As illustrated in FIG. 2, the holder 40 holds peripheral side surfaces of the plurality of secondary batteries 30. The holder 40 has a plurality of cylindrical holding portions 41 that open both ends. The holder 40 does not hold the end surfaces of the plurality of secondary batteries 30. The holder 40 is not interposed between the end surfaces of the plurality of secondary batteries 30 and the exterior case 10. The holder 40 is made of a resin such as polypropylene having electrical insulation properties.

The lead plates 50 are electrically connected to the terminals of the secondary batteries 30. Specifically, the battery pack 1 has a plurality of lead plates 50, and each of the plurality of lead plates 50 is electrically connected to the positive electrode terminal 30a and the negative electrode terminal 30b of the secondary battery 30 so that the plurality of secondary batteries 30 are electrically connected in series or in parallel.

The lead plate 50 has an embossed portion 51. The embossed portion 51 is formed in advance by, for example, press working or the like before being connected to the positive electrode terminal 30a or the negative electrode terminal 30b. The embossed portion 51 has a recessed shape and has an end surface 51a and a tapered surface 51b around the end surface 51a as illustrated in FIGS. 3 and 4.

The end surface 51a of the embossed portion 51 is in contact with and electrically connected to the positive electrode terminal 30a or the negative electrode terminal 30b. Specifically, as illustrated in FIG. 3, the end surface 51a of the embossed portion 51 is in contact with and electrically connected to a protruding end surface 33b of the protrusion 33a of the positive electrode terminal 30a. The protruding end surface 33b is a connected portion H1 of the positive electrode terminal 30a electrically connected to the lead plate 50.

As illustrated in FIG. 4, the end surface 51a of the embossed portion 51 is electrically connected to the central portion of the negative electrode terminal 30b. The central portion of the negative electrode terminal 30b is a connected portion H2 of the negative electrode terminal 30b electrically connected to the lead plate 50.

The tapered surface 51b is inclined such that the width of the embossed portion 51 decreases from the proximal end of the embossed portion 51 toward the end surface 51a.

The first member 60 surrounds the connecting portion between the terminal of the secondary battery 30 and the lead plate 50, is sandwiched between the secondary battery 30 and the lead plate 50 around the connecting portion, and has waterproofness. The first member 60 has an annular shape as illustrated in FIG. 2, and is made of, for example, elastic rubber. The battery pack 1 includes a plurality of first members 60, and the plurality of first members 60 are arranged between the positive electrode terminal 30a of the secondary battery 30 and the lead plate 50 and between the negative electrode terminal 30b and the lead plate 50, respectively.

As illustrated in FIG. 3, the first member 60 is arranged so as to surround the connecting portion C1 between the lead plate 50 and the positive electrode terminal 30a. The connecting portion C1 is a portion where the end surface 51a of the embossed portion 51 and the protruding end surface 33b of the protrusion 33a are in contact with each other. Specifically, the first member 60 surrounds the protrusion 33a. The first member 60 is sandwiched between the tapered surface 51b of the embossed portion 51 and the outer surface of the first insulating member 34 of the secondary battery 30.

The first member 60 is compressed by the tapered surface 51b of the embossed portion 51 and the outer surface of the first insulating member 34 of the secondary battery 30 so as to sufficiently exhibit the waterproof function. Since the positive electrode terminal 30a is surrounded by the first insulating member 34, if water enters the exterior case 10, the entered water does not reach the positive electrode terminal 30a. Accordingly, the positive electrode terminal 30a can be waterproofed.

As illustrated in FIG. 4, the first member 60 is arranged so as to surround the connecting portion C2 between the lead plate 50 and the negative electrode terminal 30b. The connecting portion C2 is a portion where the end surface 51a of the embossed portion 51 and the central portion of the negative electrode terminal 30b are in contact with each other. The first member 60 is sandwiched between the tapered surface 51b of the embossed portion 51 and the outer surface of the second insulating member 35 of the secondary battery 30.

The first member 60 is compressed by the tapered surface 51b of the embossed portion 51 and the outer surface of the second insulating member 35 of the secondary battery 30 so as to sufficiently exhibit the waterproof function. Since the negative electrode terminal 30b is surrounded by the second insulating member 35, if water enters the exterior case 10, the entered water does not reach the negative electrode terminal 30b. Accordingly, the negative electrode terminal 30b can be waterproofed. Therefore, the waterproofness of the battery pack 1 can be improved.

The second member 70 is in contact with the lead plate 50 and the exterior case 10, and has heat dissipation. The second member 70 has a rectangular sheet shape in plan view as illustrated in FIG. 2, and is made of, for example, silicon. Specifically, as illustrated in FIGS. 3 and 4, one sheet surface of the second member 70 is in contact with the plate surface of the lead plate 50. The other sheet surface of the second member 70 is in contact with the inner surface of the exterior case 10. That is, the second member 70 is sandwiched between the plate surface of the lead plate 50 and the inner surface of the exterior case 10. Note that the second member 70 may be compressed by the plate surface of the lead plate 50 and the inner surface of the exterior case 10 so as to exhibit a waterproof function.

Heat of the secondary battery 30 is transmitted from the positive electrode terminal 30a to the exterior case 10 via the lead plate 50 and the second member 70, and is released to the outside of the battery pack 1. Heat of the secondary battery 30 is transmitted from the negative electrode terminal 30b to the exterior case 10 via the lead plate 50 and the second member 70, and is released to the outside of the battery pack 1.

As described above, the heat transfer path through which the heat of the secondary battery 30 is transferred to the exterior case 10 includes the lead plate 50, the second member 70, and the exterior case 10. Therefore, the heat of the secondary battery 30 can be efficiently released as compared with a case where another member such as the holder 40 is present in the heat transfer path. Therefore, the heat dissipation of the battery pack 1 can be improved.

In addition, the battery pack 1 includes an external connection terminal (not illustrated) that is electrically connected to the lead plate 50 and enables charging and discharging of the secondary battery 30, and a control substrate (not illustrated) that controls charging and discharging of the secondary battery 30.

Next, a process of assembling the battery pack 1 will be described. First, the battery unit 20 is assembled. First, the plurality of secondary batteries 30 are attached to the holder 40. Subsequently, the first member 60 is attached to the plurality of secondary batteries 30 using an adhesive or the like, and further, the lead plate 50 is attached to the first member 60 using an adhesive or the like.

In this state, the connected portion H1 of the positive electrode terminal 30a and the connected portion H2 of the negative electrode terminal 30b are resistance-welded to the end surface 51a of the embossed portion 51. Resistance welding is performed by pressing a pair of electrodes against a surface of the embossed portion 51 on the side opposite to the end surface 51a. Consequently, the first member 60 is compressed by the secondary battery 30 and the lead plate 50.

Further, the second member 70 is attached to the lead plate 50 using an adhesive or the like. Thus, the battery unit 20 is completed.

Subsequently, the battery unit 20 is connected to the external connection terminal and the control substrate, and is inserted into the first case portion 11. Further, the second case portion 12 is attached to the first case portion 11. At this time, the second member 70 is sandwiched between the lead plate 50 and the exterior case 10. Thus, the battery pack 1 is completed.

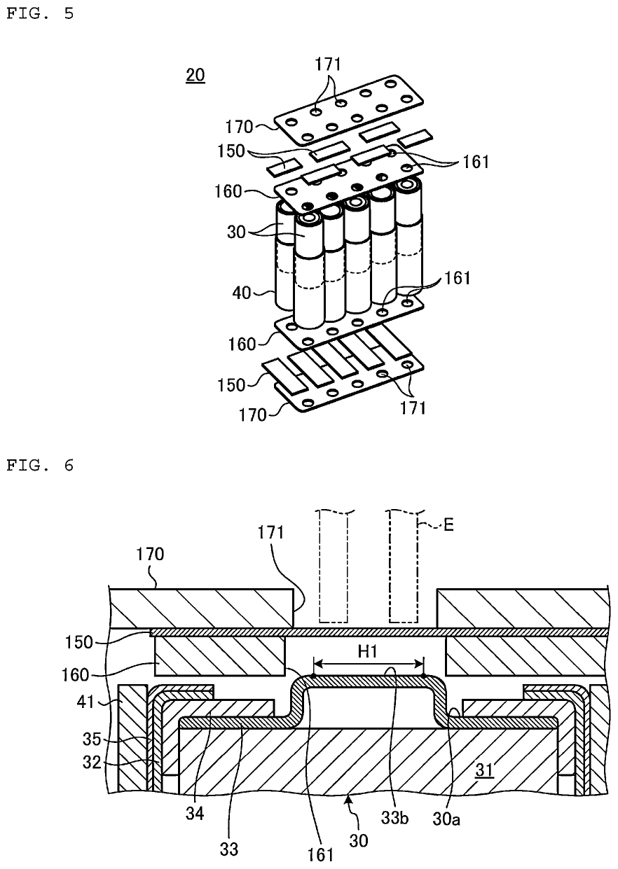

Next, a battery pack according to a second embodiment will be described mainly in terms of differences from the first embodiment. FIG. 5 is an exploded perspective view of the battery pack according to the second embodiment.

A first member 160 of the second embodiment has a rectangular sheet shape in plan view, and has a plurality of first holes 161. The first holes 161 have a size capable of surrounding the connecting portions C1 and C2. Specifically, in a state where the first member 160 is sandwiched between the secondary battery 30 and the lead plate 150, the peripheral edges of the first holes 161 surround the connected portions H1 and H2, that is, the connecting portions C1 and C2 in plan view.

The lead plate 150 of the second embodiment has a flat plate shape in which an embossed portion is not formed in advance. The second member 170 of the second embodiment has a plurality of second holes 171. The second holes 171 have a size through which a pair of electrodes E used in resistance welding pass, and in a state where the second member 170 is sandwiched between the lead plate 150 and the exterior case 10, the peripheral edges of the second holes 171 surround the connected portions H1 and H2, that is, the connecting portions C1 and C2 in plan view.

Next, the assembling process of the battery pack 1 of the second embodiment will be described with respect to differences from the first embodiment.

In the assembling process of the battery pack 1 of the second embodiment, before the first member 160 and the lead plate 150 are attached to the secondary battery 30, the lead plate 150, the first member 160, and the second member 170 are attached using an adhesive or the like such that the first hole 161 and the second hole 171 overlap each other in plan view. As a result, a set (hereinafter, it is referred to as a set of sheets) of the lead plate 150, the first member 160, and the second member 170 is assembled.

Subsequently, the set of sheets is arranged on the plurality of secondary batteries 30 such that the plurality of first holes 161 of the first member 160 surround the connected portions H1 of the positive electrode terminals 30a and the connected portions H2 of the negative electrode terminals 30b, respectively. As described above, since the lead plate 150, the first member 160, and the second member 170 are arranged on the positive electrode terminals 30a and the negative electrode terminals 30b in the assembled state, the number of assembling steps can be reduced as compared with the case where the lead plate 150, the first member 160, and the second member 170 are individually arranged as in the first embodiment.

FIG. 6 is an enlarged longitudinal sectional view of the positive electrode terminal side of the battery unit in a state where the set of sheets is arranged. In a state where the set of sheets is arranged, the lead plate 150 and the positive electrode terminal 30a are not in contact with each other. In this state, resistance welding is performed. Specifically, the tips of the pair of rod-shaped electrodes E come into contact with the lead plate 150 through the second holes 171, and the pair of electrodes E press the lead plate 150 toward the connected portions H1 (that is, the protruding end surfaces 33b).

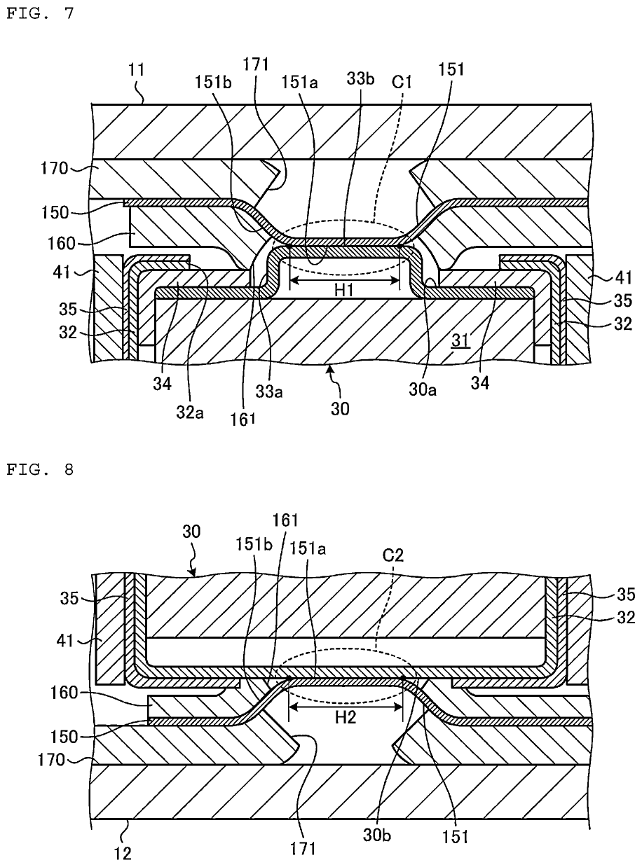

FIG. 7 is an enlarged longitudinal sectional view of the positive electrode terminal side of the secondary battery 30 in the battery pack according to the second embodiment. When the lead plate 150 is pressed by the pair of electrodes E, the lead plate 150 is deformed, and the embossed portion 151 having an end surface 151a and a tapered surface 151b is formed on the lead plate 150. Then, the end surface 151a of the embossed portion 151 and the protruding end surfaces 33b (that is, the connected portion H1) of the protrusions 33a of the positive electrode terminals 30a are brought into contact with each other and welded to each other. Accordingly, the lead plate 150 and the positive electrode terminals 30a are electrically connected to each other.

The first member 160 is sandwiched and compressed by the tapered surface 151b of the embossed portion 151 and the outer surface of the first insulating member 34 at the peripheral edge portion of the first hole 161. Accordingly, the positive electrode terminal 30a can be waterproofed. In addition, since the embossed portion 151 of the second embodiment is formed at the time of welding, as compared with the case where the embossed portion 151 is formed in advance before welding as in the first embodiment, it is not necessary to perform a step of forming the embossed portion 151 in advance on the lead plate 150 and to position the embossed portion 151 and the positive electrode terminal 30a. Therefore, the number of assembling steps of the battery pack 1 can be reduced.

In addition, since the second member 170 is attached to the lead plate 150 before resistance welding, the peripheral edge portion of the second hole 171 is deformed so as to follow the deformation of the lead plate 150 due to resistance welding, and is in contact with the lead plate 150. That is, the peripheral edge portion of the second hole 171 is in contact with the embossed portion 151. Specifically, the peripheral edge portion of the second hole 171 is in contact with the embossed portion 151 around the end surface 151a of the embossed portion 151. Therefore, the second member 170 can efficiently transfer the heat of the secondary battery 30 to the exterior case 10 as compared with the case where the second member 170 is away from the embossed portion 151 as in the first embodiment.

FIG. 8 is an enlarged longitudinal sectional view of the negative electrode terminal side of the secondary battery in the battery pack according to the second embodiment. Also on the negative electrode terminal 30b side, when the lead plate 150 is pressed by the pair of electrodes E in resistance welding, the lead plate 150 is deformed, and the embossed portion 151 having the end surface 151a and the tapered surface 151b is formed on the lead plate 150. Then, the end surface 151a of the embossed portion 151 and the central portion (that is, the connected portion H2) of the negative electrode terminal 30b are brought into contact with each other and welded. Accordingly, the lead plate 150 and the negative electrode terminal 30b are electrically connected to each other.

The first member 160 is sandwiched and compressed by the tapered surface 151b of the embossed portion 151 and the outer surface of the second insulating member 35 at the peripheral edge of the first hole 161. Accordingly, the negative electrode terminal 30b can be waterproofed.

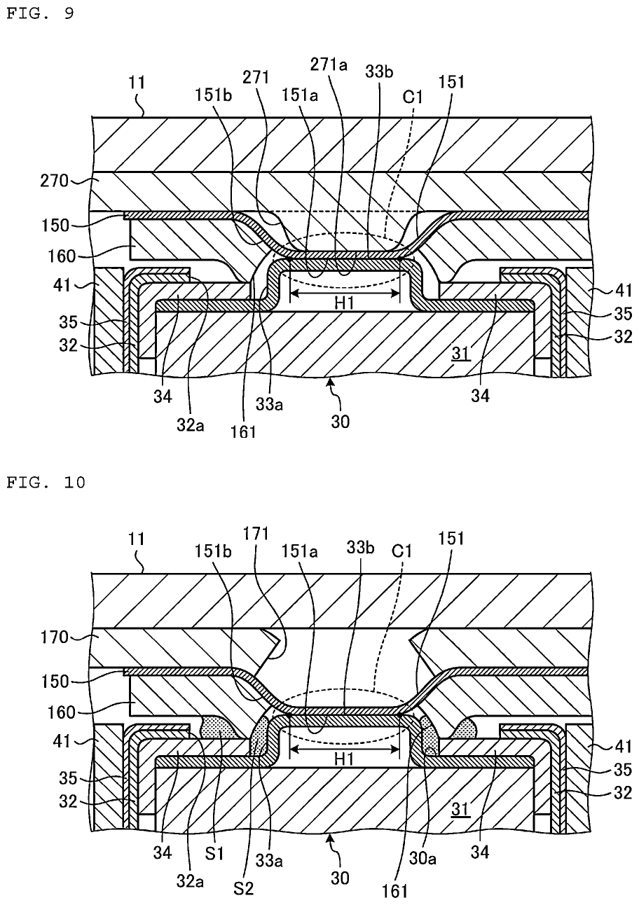

Next, a battery pack 1 according to a third embodiment will be described mainly in terms of differences from the second embodiment. FIG. 9 is an enlarged longitudinal sectional view of the positive electrode terminal 30a side of the secondary battery 30 in the battery pack according to the third embodiment.

A second member 270 of the third embodiment has a shape that comes into contact with each of the lead plate 150 and the exterior case 10 at positions overlapping the connecting portions C1 and C2 in plan view. Specifically, the second member 270 has a plurality of protruding portions 271 protruding toward the secondary battery 30. The second member 270 does not have the second holes 171.

The protruding portion 271 is at a position where a surface of the embossed portion 151 on the side opposite to the end surface 151a is in contact with a protruding end surface 271a. The sheet surface of the second member 270 on the side opposite to the protruding portion 271 is in contact with the inner surface of the exterior case 10. That is, in the third embodiment, the embossed portion 151 and the exterior case 10 are connected with the protruding portion 271 interposed therebetween.

On the positive electrode terminal 30a side of the secondary battery 30, heat of the secondary battery 30 is transmitted from the positive electrode terminal 30a to the exterior case 10 via the embossed portion 151 of the lead plate 150 and the protruding portion 271 of the second member 270. On the other hand, on the negative electrode terminal 30b side of the secondary battery 30, the heat of the secondary battery 30 is transmitted from the negative electrode terminal 30b to the exterior case 10 via the embossed portion 151 of the lead plate 150 and the protruding portion 271 of the second member 270. Therefore, as compared with the case where the second member 70,170 does not have the protruding portions 271 as in the first and second embodiments, the length of the heat transfer path through which the heat of the secondary battery 30 is transferred to the exterior case 10 is shortened.

In addition, the volume of the space between the embossed portion 151 and the exterior case 10 in the third embodiment is smaller than that in the first and second embodiments because the protruding portion 271 is positioned in the space. Therefore, the second member 270 of the third embodiment can efficiently transfer the heat of the secondary battery 30 as compared with the case where the second member 70,170 does not have the protruding portions 271 as in the first and second embodiments.

Note that, in the third embodiment, the second member 270 is attached to the lead plate 150 after the lead plate 150 is resistance-welded to the positive electrode terminals 30a and the negative electrode terminals 30b.

Next, a battery pack 1 according to a fourth embodiment will be described mainly in terms of differences from the second embodiment. FIG. 10 is an enlarged longitudinal sectional view of the positive electrode terminal side of the secondary battery 30 in the battery pack according to the fourth embodiment. The battery pack 1 according to the fourth embodiment further includes a waterproof material S1 and a waterproof material S2.

The waterproof material S1 and the waterproof material S2 are, for example, silicon-based waterproof materials. On the positive electrode terminal 30a side of the secondary battery 30, the waterproof material S1 and the waterproof material S2 are filled between the secondary battery 30 and the lead plate 150 around the portion where the first member 160 is sandwiched. Specifically, the waterproof material S1 is filled on the radially outer side of the secondary battery 30 with respect to a portion where the first member 160 and the first insulating member 34 are in contact with each other between the secondary battery 30 and the lead plate 150. In addition, the waterproof material S2 is filled on the radially inner side of the secondary battery 30 with respect to a portion where the first member 160 and the first insulating member 34 are in contact with each other between the secondary battery 30 and the lead plate 150, and on the radially outer side of the secondary battery 30 with respect to the connected portion H1.

The positive electrode terminal 30a can be more reliably waterproofed by the waterproof material S1 and the waterproof material S2. Note that the battery pack 1 may include any one of the waterproof material S1 and the waterproof material S2.

On the other hand, on the negative electrode terminal 30b side of the secondary battery 30, the waterproof material S1 is filled on the radially outer side of the secondary battery 30 with respect to the portion where the first member 160 and the second insulating member 35 are in contact with each other between the secondary battery 30 and the lead plate 150. In addition, the waterproof material S2 is filled on the radially inner side of the secondary battery 30 with respect to the portion where the first member 160 and the second insulating member 35 are in contact with each other, and on the radially outer side of the secondary battery 30 with respect to the connected portion H2. The negative electrode terminal 30b can be more reliably waterproofed by the waterproof material S1 and the waterproof material S2.

In the assembling process of the battery unit 20, the waterproof material S1 and the waterproof material S2 are applied to the periphery of the connected portion H1 of the positive electrode terminal 30a and the periphery of the connected portion H2 of the negative electrode terminal 30b before the first member 160 is attached to the secondary battery 30. Subsequently, the first member 160 and the lead plate 150 are attached to the secondary battery 30, and the positive electrode terminal 30a and the negative electrode terminal 30b are resistance-welded to the lead plate 150, whereby the waterproof material S1 and the waterproof material S2 are filled at the above positions. Note that, after the positive electrode terminal 30a and the negative electrode terminal 30b are resistance-welded to the lead plate 150, the waterproof material S1 may be applied from the periphery where the first member 160 is sandwiched.

Note that the battery pack 1 according to the fourth embodiment may not include the second member 170. In this case, the plate surface of the lead plate 150 comes into contact with the inner surface of the exterior case 10.

Note that the embodiments described above are intended to facilitate understanding of the present disclosure, but not intended to construe the present disclosure in any limited way. The present disclosure may be modified/improved without departing from the spirit thereof, and the present disclosure includes equivalents thereof.

### DESCRIPTION OF REFERENCE SYMBOLS

1: Battery pack
10: Exterior case
30: Secondary battery
30a: Positive electrode terminal (terminal)
30b: Negative electrode terminal (terminal)
34: First insulating member (insulating member)
35: Second insulating member (insulating member)
50: Lead plate
51, 151: Embossed portion
51a, 151a: End surface
60: First member
70: Second member
171: Second hole (hole)
271: Protruding portion
C1, C2: Connecting portion
H1, H2: Connected portion
S1, S2: Waterproof material

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a secondary battery;
an exterior case that houses the secondary battery;
a lead plate electrically connected to a terminal of the secondary battery;
a first member that surrounds a connecting portion where the terminal and the lead plate are connected, is sandwiched between the secondary battery and the lead plate around the connecting portion, and has waterproofness; and
a second member that is in contact with the lead plate and the exterior case and has heat dissipation.

2. The battery pack according to claim 1, wherein
the secondary battery has a columnar shape, and
the battery pack further includes a holder that holds a peripheral side surface of the secondary battery and opens both ends.

3. The battery pack according to claim 1, wherein
the second member has a hole, and
a peripheral edge of the hole surrounds the connecting portion in plan view.

4. The battery pack according to claim 3, wherein
the lead plate has an embossed portion having a recessed shape,
an end surface of the embossed portion constitutes the connecting portion connected to the terminal, and
a peripheral edge portion of the hole is in contact with the embossed portion around the end surface.

5. The battery pack according to claim 1, wherein the second member has a shape in contact with each of the lead plate and the exterior case at a position overlapping the connecting portion in plan view.

6. The battery pack according to claim 1, wherein
the secondary battery includes an insulating member surrounding a connected portion of the terminal to which the lead plate is connected, and
the first member is sandwiched between the insulating member and the lead plate.
